(19) United States
(12) Patent Application Publication
(10) Pub. No.: US 2026/0211391 A1
(43) Pub. Date: Jul. 23, 2026

(54) Method for Operating a Production System, Computer Program, and Data Carrier

(71) Applicant: Bayerische Motoren Werke Aktiengesellschaft, Muenchen (DE)

(72) Inventors: Ingo HEINLE, Inzell (DE); Tom Janis KRAUSE, Muenchen (DE); Christian SCHELSKE, Marklkofen (DE)

(21) Appl. No.: 19/157,780

(22) PCT Filed: Mar. 27, 2024
(86) PCT No.: PCT/EP2024/058312

§ 371 Date: Aug. 19, 2025

(30) Foreign Application Priority Data
Apr. 19, 2023 (DE) 10 2023 109 857.8

(51) Int. Cl. G05B 19/042

(52) U.S. Cl. CPC G05B 19/0426; G05B 2219/25294

(57) ABSTRACT

A method for operating a production system that produces a component from a semi-finished product in a process includes ascertaining a parameter set using a model, and determining the stability of the model using the following steps: detecting an error value of a semi-finished product property and/or a state variable and/or a process parameter; forming a data set for the semi-finished product comprising a semi-finished product value comprising the corresponding error value, the state variable comprising the corresponding error value, and a process parameter comprising the corresponding error value for a semi-finished product property; selecting at least one control value in the interval formed by the respective error value; forming a control set including correspondence data by the model using the selected control value; forming the difference between the data set and the control set; and deriving a threshold from the difference.

### BACKGROUND AND SUMMARY

The invention relates to a method for operating a production system which produces a component from a semifinished product having at least one semifinished product property in a process, which is characterized by a parameter set comprising at least one process parameter. Furthermore, the invention relates to a computer program and an electronically readable data carrier.

In motor vehicle construction, for example, in the production of passenger vehicles, production systems are often used. Such a production system can be, for example, part of a pressing plant for producing vehicle body components. The production of vehicle body components in pressing plants is divided into multiple process steps. Initially, blanks are cut from a coil on the coiling system. Trackable stacks of blanks can thus be formed, which are generally temporarily stored before the processing in the pressing line. For example, deep drawing of a flat plate, which is formed, for example, from the cut blank, takes place in the pressing line. Further process steps, such as trimming and/or post-forming, can follow the deep drawing.

The semifinished products or fine plates processed in the pressing plants typically have variations with respect to their properties, in particular semifinished product properties. For example, a plate thickness, a lubricant amount, a roughness, and an elastoplastic material property can vary. Depending on the form of this variation, it can be necessary to adapt process parameters of the production process in order to achieve a required quality of the produced components, the component quality. In general, in most pressing plants, the adaptation of the process parameters, which is connected to a shutdown time of the system, is carried out based on experience by a plant controller. Depending on the duration during the ascertainment of a matching process parameter combination, significant costs can arise in particular due to the shutdown of the production process.

In order to avoid or reduce the mentioned shutdown times when finding process parameters for eliminating problems, there are approaches for introducing a process control which uses an algorithm. This algorithm can take into consideration semifinished product properties of the blank to be processed, a state of the blank, such as a temperature, a state of the tools, such as a surface temperature, and states of the press, such as the temperature of the hydraulic fluid in the drawing cushion, and generate proposals for a matching selection of the process parameters.

A problem which can occur here is that, for example, measurement inaccuracies in the determination of the semifinished product properties and/or the states can change predictions of an algorithm and, in particular in the case of a nonlinear relationship between the individual states or semifinished product properties, this algorithm can supply incorrect results or proposals due to instabilities.

It is therefore an object of the present invention to provide a method, a computer program, and a data carrier, by which a production system can be operated particularly advantageously in that instabilities in the determination of parameters used for operating a process of the production system can advantageously be identified.

This object is achieved according to the invention by the subject of the present disclosure. Advantageous embodiments and refinements of the invention are also specified in the description and the drawings.

A first aspect of the invention relates to a method for operating a production system, which produces a component from a semifinished product having at least one semifinished product property in a process, which is characterized by a parameter set comprising at least one process parameter, wherein the set of process parameters is specified and/or a component quality is ascertained by a trained model on the basis of the at least one semifinished product property and a stability of the trained model is determined using the following steps:

In a first step, at least one error value of the at least one semifinished product property and/or at least one state variable and/or the at least one process parameter and/or the component quality is detected. In a second step, a respective data set for the at least one semifinished product is formed, which, for the at least one semifinished product property, comprises a semifinished product value and the associated error value and/or the state variable and the associated error value and/or the at least one process parameter with associated error value and/or the component quality with associated error value. In a third step, at least one control value is selected in the interval formed by the respective error value around the semifinished product value and/or the state variable and/or the process parameter and/or the component quality. In a fourth step, a control set, which comprises correspondence data, is formed by the trained model on the basis of the at least one selected control value. In a fifth step, a difference is formed between the respective data set and the control set. Finally, in a sixth step, a threshold value is derived from the difference formed.

The production system can be, for example, a pressing line for motor vehicle construction. The semifinished product is, for example, a blank which has as the at least one semifinished product property, for example, a plate thickness, lubricant quantity, or roughness. The semifinished product value describes the dimension of the semifinished product property and its actual value here, for example, the plate thickness in millimeters. The at least one state variable can represent, for example, the current temperature of the semifinished product, a temperature of a tool of the production system, an ambient humidity, or the like. The process parameter can represent, for example, if the production system comprises a press, a press parameter, which characterizes, for example, drawing cushion forces, kinematics of a plunger movement, a position of a plate holder, and/or the application of additional lubricant to the semifinished product. Further process parameters can be tool parameters, such as drawing aids, gas filling of gas pressure springs, and/or the definition of a position of a guide. The process parameter can therefore characterize an adjustment option on tools. Furthermore, a directional apparatus at the coiling system can also be set via process parameters.

The correspondence data of the control set comprise values determined by the method for the selected control value(s) of the at least one semifinished product value, the at least one process parameter, the at least one state variable, and/or the component quality. The selection can, for example, in particular take place uniformly distributed over a control value space by an optimization method and/or by a random selection. By specifying the desired number of control values, for example, by a user, the time required to form the control set can be influenced, for example.

The component is, for example, a deep-drawn sheet-metal component, which is formed by pressing or deep drawing from the semifinished product by the production system, which in particular comprises a press. The trained model in particular comprises a self-learning algorithm and/or a neural network. Trained means that the model has been trained with the aid of training data to specify process parameters, by which a desired component quality can be obtained during the production of the component by the production system. Additionally or alternatively, the model can be designed so that upon input of the semifinished product properties and the parameter set, which characterizes a set of process parameters, a component quality can be assessed by the model.

A possibility for analysis of the stability of predictions of the trained or self-learning model and therefore of machine learning models is proposed by the method according to the invention. The method is capable of assessing the at least one process parameter and additionally or alternatively predicting the component quality. In the first case, the control value is therefore based, for example, on the at least one semifinished product value and the at least one state variable. In the second case, the control value can be based on the at least one semifinished product value, the at least one state variable, and the at least one process parameter.

Furthermore, the method according to the invention is capable of analyzing both the stability of the trained model or the self-learning model before startup and in running operation. For both applications, a determination or assessment of the measurement inaccuracies and therefore of the error value of all measured variables which are used as input data for the model is required or made. The detection in the first step of the method is therefore in particular measuring and/or retaining and/or determining or retrieving the respective error value, which can in particular describe a measurement inaccuracy or uncertainty of the at least one semifinished product property, the state variable, and/or the at least one process parameter of the parameter set or the component quality. In general, the process parameters are setting values which are set or specified at the production system. The actual values of the process parameters can deviate therefrom. These values can be referred to as measured process parameters. The uncertainty, which can form a basis of the respective associated error value, is only determined here for measured process parameters. For the non-measured process parameters, an uncertainty cannot be determined in the sense of the measurement accuracy, but an estimation can take place for the detection of the respective associated error value, for example, which can be expected, for example, due to an assumed allowance in the production system. At least one of the respective error values can also be specified by a requirement for the component quality or a quality for the prediction can be derived from a quality requirement. Furthermore, it is conceivable that the respective error value is estimated on the basis of a specification.

The invention is based on the finding here that in the recommendation of process parameters by a self-learning model, measurement inaccuracies or error values, for example, of the sensors used, are to be taken into consideration for determining semifinished product properties and/or states.

It is thus possible to proceed from a situation, for example, that a first blank or a first semifinished product has semifinished product properties. A second blank has semifinished product properties different from the first blank, wherein these only differ slightly within the measurement tolerance or the measurement accuracy and can therefore be within the error value.

As already mentioned, the trained model or the self-learning algorithm can be used, on the one hand, to output recommendations of process parameters or to output a prediction of the quality of the produced components. It is desired for the first case that the algorithm or the model gives a recommendation of a parameter set which comprises the at least one process parameter for these two blanks or semifinished products. While assuming identical values of the state variables, since these correspond to identical values of the state variables or semifinished product properties in the scope of the measurement accuracy, identical process parameters are also to be recommended or these only differ very slightly from the respective other proposal for the respective semifinished product or the respective blank. If large differences in the values of the process parameters now occur in the prediction or the proposal of the process parameter sets by the model, this can be an indication that the model is not sufficiently stable to recommend reliable values for the at least one process parameter.

In particular in the case of machine learning models or trained models, which take into consideration nonlinear relationships between semifinished product properties, state variables, and process parameters, it thus cannot be precluded that instabilities will occur. If an instability occurs, the prediction of the model is not reliable. Possible causes of such an instability can be an inadequate measurement accuracy of the input variables, furthermore the model can have local discontinuities and/or so-called overfitting can be present.

It is decisive that the assessment of this instability can be performed for points in the space of the input data which were not part of the data for the training, validating, and testing of the model. The method can also use the training phase for data for training the model.

In addition, the method can also be used in models which are based, for example, on a linear regression model, since, for example, due to the large number of parameters, semifinished product properties, and states, stability problems can occur due to an error propagation. For example, a length extension of a material is dependent on an ambient temperature, which can represent a state variable. If the ambient temperature is now determined very inadequately, for example, a measured thickness can be incorrectly determined on the basis of the temperature-dependent length extension. In the case of many variables for the model, such as semifinished product properties, state variables, and process parameters, an indication can thus be supplied by the method that an inadequate measurement accuracy can be present.

An instability can occur in the prediction of the quality of the produced component in a machine learning model. If the prediction of the quality based on the values which characterize the semifinished product properties of the first blank differs significantly from the prediction of the second blank in the mentioned example, this can likewise indicate an instability of the model. In this case, the cause can be the model used and also an inadequate measurement accuracy of the semifinished product properties or the states, however.

It is crucial to identify such instabilities in order to be able to ensure satisfactory operation of the production machine or the model used here to recommend process parameters and/or the component quality. One advantage of the method presented according to the invention is that such instabilities can be discovered in an advantageous manner.

In an advantageous embodiment of the invention, in the case of a difference less than the threshold value, the model is used for the operation of the production system and/or the at least one component is produced using the set of process parameters determined by the model. In other words, if the result has been that no instabilities are to be expected due to the model, the model which was used in the method up to this point is used further. Additionally or alternatively, process parameters or the parameter set which is generated by the model to operate the system can be used to produce the component by the production system. The advantage thus results that the component produced by the method has a particularly high component quality.

In a further advantageous embodiment of the invention, the data set is formed as a hypercuboid, the center point of which is formed by the at least one semifinished product value and/or the at least one state variable and/or the at least one process parameter and/or the component quality and the respective, in particular corresponding or associated edge length of which to the respective value or parameter is specified by the associated error values, which were in particular detected in the first step and each form an interval (error interval specifies edge length). The at least one semifinished product value, the at least one state variable, the at least one process parameter, and the component quality can in combination be considered to be input variables for the model. In other words, the hypercuboid forms a space of input variables which is delimited by the measurement inaccuracy, wherein the point is used as the center point of the hypercuboid which describes all measured values of the semifinished product properties and states and optionally additionally also the process parameters or the component quality. In other words, the center point represents the actually measured or determined values. The input variables can therefore also be combined as the input space. The data set thus provides the coordinates for the center point, wherein the dimension of the hypercuboid corresponds to the number of the entries of the data set. The number of the entries is equal here to the sum of semifinished product values, state variables, process parameters, and/or the component quality contained in the data set. Due to a type of the error value, the space which the hypercuboid forms could contain values for a semifinished product property or a state variable which cannot physically occur. For example, in a measurement of the lubricant quantity, a value of 0 could result. If a measurement accuracy of +/−0.1 g/m² is presumed, the hypercuboid can comprise negative values for the lubricant quantity. The hypercuboid is therefore to be delimited such that no physically impossible values for the semifinished product properties and/or state variables can result. The extension of the hypercuboid can thus accordingly be reduced in the respective dimensions so that the hypercuboid does not contain any semifinished product properties or states which are not physically possible. In principle, the size of the hypercuboid is exclusively reduced by this measure. The advantage results due to the hypercuboid that the selection in the third step of the method can take place particularly advantageously.

In a further advantageous embodiment of the invention, the at least one control value is selected by a sample taking method and/or by an optimization method. In other words, the control value is ascertained from the space of the input variable or in particular, for example, from the hypercuboid on the basis of a sample taking method, for example, randomly based, and/or by an optimization method, for example, by a maximum search around the center point of the hypercuboid. The advantage can result due to the use of the optimization method that a control value can be found which corresponds to the maximally most unfavorable effect of an instability. If a sample taking method is used, the advantage can result that, for example, a uniform distribution of multiple control values is provided, so that instabilities can advantageously be revealed. This can in particular be the case if the optimization method terminates excessively early due to a discontinuity of a target function.

In a further advantageous embodiment of the invention, the sample taking method comprises a Latin hypercube method. In other words, points are generated in the hypercuboid, which are used as control values that are selected by Latin hypercube. The advantage thus results that the at least one control value corresponds to a sample, which reflects a uniform distribution of the at least one selected control value and in particular multiple selected control values over the respective interval of the error values and therefore can be advantageous in relation to a random sample.

In a further advantageous embodiment of the invention, if at least two control values are used and can therefore comprise the difference of at least two difference values, an aggregated difference is formed. In other words, for the respective data set, if multiple control values are ascertained for this, all differences are determined and these are aggregated to form a single difference. It is thus conceivable, for example, that the maximum difference is used as a value for a further observation, wherein this value can form the aggregated difference. The advantage thus results that the threshold value can be formed in a particularly advantageous manner. Furthermore, the maximum threshold value in particular can form a very advantageous variable for judging the instability.

In a further advantageous embodiment of the invention, the derivation of the threshold value is carried out by a statistical assessment of the aggregated difference and/or by target specification, in particular of the component quality. A limiting value can thus be derived, for example, from the distribution of the calculated differences, which can be used as the threshold value. Additionally or alternatively, the threshold value can result from the quality requirements which are placed on the process. In the case of the statistical assessment, standardized statistical methods and values such as mean value variance, standard deviation, and further ones can be considered. The advantage results in this way that an instability can be concluded in a particularly advantageous manner on the basis of the determination of the threshold value.

In a further advantageous embodiment of the invention, a warning signal is output if the difference is greater than the threshold value. Additionally or alternatively, a further trained model and/or an updated training data set can be proposed for the currently used model. In other words, if an instability is found, a user of the production system can be warned and/or alternatives can be proposed to this user for determining the process parameters or the parameter set. The advantage thus results that the production system can be operated particularly advantageously. The study of the stability can thus take place in particular during the application of the model.

In a further advantageous embodiment of the invention, for the at least one data set of the at least one semifinished product value and/or the at least one state variable and/or the at least one process parameter and/or the component quality, a training data set and/or a validation data set and/or an operating data set, which comprises data which are generated during the operation of the model and/or an artificial data set, which comprises data which are artificially generated, can be used. In other words, the data set is formed from the set of the training data and/or from data for validating the prediction quality. Additionally or alternatively, the data set is formed from the at least one semifinished product property and/or at least one state variable and/or the at least one process parameter and/or the component quality currently used in operation. Additionally or alternatively, for example, by interpolation, data for the at least one semifinished product property and/or the at least one state variable and/or the at least one process parameter and/or the component quality can be artificially generated. An assessment can thus be performed for points in the space of the input data which were not part of the data for the training, validating, and testing of the model. The advantage thus results that a particularly advantageous validation of the model and therefore an ascertainment of its stabilities are possible. Furthermore, the advantage results that instabilities of the model can already be studied in its training phase.

A second aspect of the invention comprises a computer program. The computer program can, for example, be loaded into a memory of the electronic computing device of a production system and comprises a program in order to carry out the steps of the method when the computer program is executed in the electronic computing device or a control device.

Advantages and advantageous embodiments of the first aspect of the invention are to be viewed here as advantages and advantageous embodiments of the second aspect of the invention and vice versa.

A third aspect of the invention relates to an electronically-readable data carrier. The electronically-readable data carrier comprises electronically-readable control information stored thereon, which comprises at least one computer program as just presented and is designed such that it can carry out a method presented here according to the first aspect of the invention upon the use of the data carrier in an electronic computing device.

Advantages and advantageous embodiments of the third aspect of the invention are to be viewed here as advantages and advantageous embodiments of the second and the first aspect of the invention and vice versa.

Further features of the invention result from the claims, the figures, and the description of the figures. The features and combinations of features mentioned above in the description and the features and combinations of features mentioned hereinafter in the description of the figures and/or solely shown in the figures are usable not only in the respectively specified combination, but also in other combinations or alone.

The invention will now be explained in more detail on the basis of a preferred exemplary embodiment and with reference to the drawings.

### BRIEF DESCRIPTION OF THE DRAWINGS

FIG. 1 shows a schematic flow chart of a method for operating a production system; and

FIG. 2 shows a schematic view of a data set, formed as a two-dimensional hypercuboid, for the method.

### DETAILED DESCRIPTION OF THE DRAWINGS

Production systems are used, for example, to produce vehicle body components, wherein a production system can therefore comprise a press or a pressing line and produces a component in the form of the vehicle body component from a semifinished product, such as a blank cut from a coil. The production system is operated here using process parameters advantageous for the process for producing the component, which enable a certain component quality. The process parameters are adapted, for example, to a respective semifinished product property of the respective semifinished product for the forming, wherein process parameters can be proposed by a self-learning algorithm or as a self-learning or trained model. Such a model can have instabilities.

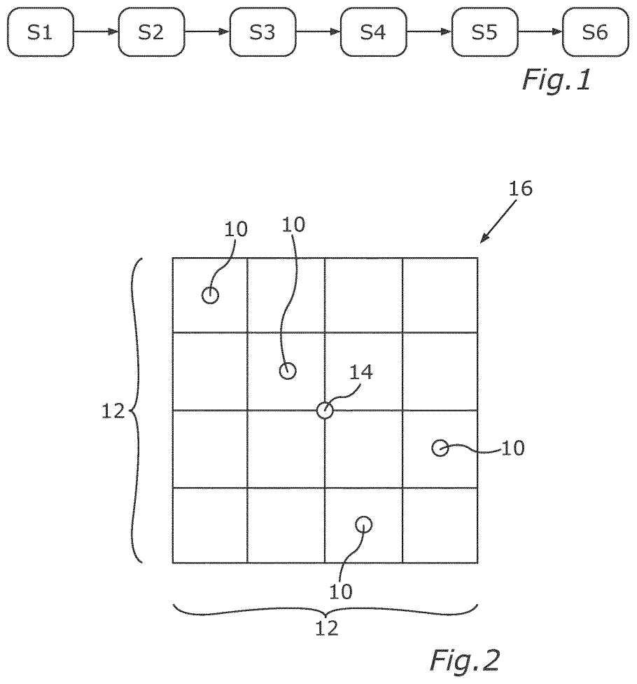

An analysis of the stability of the model can be performed by the method presented here, so that the production system can be advantageously operated. FIG. 1 thus shows a schematic diagram for a method for operating a production system, which produces a component from a semifinished product having at least one semifinished product property in a process, which is characterized by a parameter set comprising at least one process parameter, wherein the parameter set is specified by a trained model on the basis of the at least one semifinished product property and/or a component quality is ascertained. The stability of the trained model is determined using steps S1 to S6 shown in FIG. 1.

In first step S1, at least one error value of the at least one semifinished product property and/or a state variable and/or the at least one process parameter and/or the component quality is detected. In a second step S2, a data set is formed for the at least one semifinished product, which comprises a semifinished product value for the at least one semifinished product property, which therefore characterizes or describes the semifinished product property, with the associated error value, in particular to be understood as a measurement inaccuracy, and/or the state variable with the associated error value and/or the at least one process parameter with the associated error value and/or the component quality with the associated error value. The respective error value of the at least one semifinished product value, the at least one state variable, and the at least one process parameter describes here, for example, an uncertainty, in particular a measurement uncertainty and therefore a deviation between target values and actual values. In the case of the component quality, the error value is to be interpreted as a specified quality requirement and can in particular assume the value zero. In third step S3, at least one control value 10 is selected in the interval 12 formed by the respective error value around the semifinished product value and/or the state variable and/or the process parameter and/or the component quality. In fourth step S4, a control set is formed, which comprises correspondence data, by the trained model on the basis of the at least one selected control value 10. In a fifth step S5, a difference is formed between the data set and the control set. Finally, in sixth step S6, a threshold value, which forms a measure of the instability of the model, is derived from the difference formed.

The trained model can be designed in particular as a machine learning model and can therefore be embodied, for example, as a self-learning algorithm and/or neural network. Additionally or alternatively, the trained model can be a simulation model and/or can describe a mathematical function. In order that the production system can advantageously be operated, in the event of a difference less than the threshold value, thus in the event of the absence of an instability, the model used in the method is used for the operation of the production system; the at least one component can thus be produced using the parameter set determined by the model. The stability of the model can be analyzed both before startup and also in running operation by the method, wherein, for both application cases, a determination and/or estimation or at least one detection of the error value and therefore the respective measurement inaccuracy of the respective variable, thus the semifinished product value, the state variable, the process parameter, or the component quality takes place and the data set is thereupon formed. The data of this data set can in particular be at least partially used as input data for the trained model.

In one phase, an observation of the startup or the training of the model can thus initially take place. After the training of the model or the respective model, each of the data sets can be formed from a set of training data and also from data which are used for validating the prediction quality or the component quality.

It is also conceivable to deliberately generate a combination of semifinished product properties and state variables artificially during the training and also test this combination. The stability of the model can therefore already be analyzed in the training phase upon an extrapolation or previously unknown point in space of the semifinished product properties and state variables. A study of boundaries of a specification limit of the semifinished products could particularly be of interest in this case, for example, since the training data generally do not cover the entire permissible interval of the semifinished product properties. The model does not have to be studied for instabilities outside the specification limits, since the processing of such a material is not permissible. It is thus conceivable to form a second hypercuboid, which maps the specification limits and to deliberately search the entire space for instabilities via sampling. New points are selected here in this space and therefore data sets are formed and subsequently the at least one control point is produced for each data set. A similar procedure can be used in the case of the state variables. However, there is no specification for these variables. Therefore, for such a study, the possible limits of the state variables have to be estimated. The model can therefore be checked particularly well in particular by repeating the method on different data sets.

A data set contains the data or variables which result from the manufacturing or the production of the individual component or relate thereto. In the method, the surroundings in the space of the input variables comprising the semifinished product properties and state variables are observed. This space is delimited by the measurement accuracy or the respective error value.

It is to be noted in the observation of the error values that process parameters are generally setting values and therefore do not have a measurement accuracy. However, the real value can deviate from the setting values, so that the associated error values can be formed from a difference of target value and actual value. Similarly, a target specification can be used as the error value in the prediction of the component quality.

Each state variable, process parameter, and/or semifinished product value forms a separate dimension, so that the limits formed by the error values can be the surfaces of a hypercuboid 16. The point 14, which describes all measured values of the semifinished product properties and state variables, is used as the center point or focal point of the hypercuboid 16. Additionally or alternatively, this can furthermore describe the component quality or the parameter set. The values can all be combined to form a vector. It is thus advantageous if the data set is formed as the mentioned hypercuboid 16 shown in FIG. 2, the respective edge length of which is formed by the respective interval 12. If the respective interval 12 has an extension at least in one direction which is formed in combination with the location of the associated value around the interval 12, having the result that parts of the interval do not assume physically reasonable or in particular possible values, the interval 12 can thus be trimmed accordingly. The point 14 can thus travel out of the middle or the center of the hypercuboid.

FIG. 2 thus shows a hypercuboid in two dimensions, wherein a tool property, such as the plate thickness, is plotted in the vertical direction, for example, and the interval more or less characterizes the interval of the error value. A state variable, such as the temperature of the semifinished product, with corresponding measurement inaccuracy, can be mapped along the longitudinal direction or transverse direction or horizontal direction, as the further interval 10.

FIG. 2 furthermore shows on the basis of the control values 10 shown that they are selected by a special sample taking method, the so-called Latin hypercube method, and this takes place via a special uniform distribution over the space of the input variables. The sample taking method or Latin hypercubing represents sampling in order to obtain samples which represent the control values 10. Thus, n points, four in FIG. 2, can be generated in the space of the measurement accuracies or in the space of the error values within the hypercuboid 16, wherein a prediction of the machine learning model or the trained model for the at least one process parameter of the parameter set and/or the component quality is executed for each generated point. The difference between the prediction at the point 14, thus the center of the hypercuboid, and the prediction executed for the analysis of the stability of the learning model, thus with the respective control values 10, can then be calculated, compared, or formed by a difference formation. A calculation of this difference is carried out in particular for each available data set. For further observation, it can be reasonable to aggregate the calculated differences of each data set to form a single difference. That is to say, if at least two control values 10 are used, the difference can comprise at least two difference values, which can be combined to form an aggregated difference value.

Alternatively, instead of the sample taking method, for example, an optimization method can be used to determine or select the at least one control value 10. The greatest possible difference of the predictions between the point 14 and further points which are determined by the control values 10 can be found by the optimization method. An optimum and therefore the maximum of the aggregated difference can therefore be found in a simple manner by the optimization method, for example. The instability can thus be judged particularly advantageously.

The derivation of the threshold value or the limiting value which characterizes the stability can advantageously be carried out via a statistical assessment of the calculated aggregated differences and/or on the basis of a target specification. The derivation of the threshold value could also relate to the points which were used for the training. At these points, there is a particularly low risk that instabilities will occur. The threshold value or limiting value can be derived here from the distribution of the calculated differences, for example. All differences which exceed the threshold value indicate an instability. If instabilities are found, the user can thus be warned. This user can thereupon in turn change the selection or the method for training the model in order to use a model having a small number and/or advantageously without established instabilities for operating the production system. This can furthermore be proposed by the method itself.

Alternatively or additionally, the threshold value can be derived, for example, from a measurement inaccuracy of the component quality of the produced or manufactured component if it is a model which predicts the component quality. Two embodiments are thus essentially provided by the method: On the one hand, the model, the stability of which is to be checked, is used to determine the parameter set and, alternatively, the model or a further model is used to determine the component quality, due to which corresponding combinations can result in the exemplary embodiment. If the model recommends the parameter set, the threshold value can also be determined in that it is determined in the scope of experiments and/or based on experience in which order of magnitude a change of the process parameters is to be performed so that a measurable change of the component quality results.

The assessment of the stability can additionally also take place during the operation of the model. The stability is only determined here for the current data set, for which a prediction is to be performed; the limiting value or threshold value can be obtained here, for example, from a preceding pass of the method.

The presented method can also be used for other types of predicted variables or production systems other than pressing lines.

In addition to the method, a computer program and a data carrier for judging the stability of predictions of machine learning models for the production process are to be presented, wherein the computer program is designed to carry out the method upon execution on an electronic computing device and the data carrier can comprise corresponding program steps of the computer program.

Advantages of the method, the computer program, and the data carrier are, for example, the possibility of specifying the number of the observed control values. It is therefore possible to assess a computing demand for the method and to establish a reasonable selection with respect to the amount of the control values depending on the stated object. It can therefore be ensured that a specified duration for the execution and control of a production is not exceeded. This applies both for the sampling and for the optimization method. In principle, a prediction can also be calculated in parallel on multiple computing cores of the electronic computing device, by which the method can be scaled.

A knowledge about the distributions of the measured values with respect to semifinished product properties, state variables, or measured process parameters is not required for the application of the method.

Since the measurement accuracy of sensors is typically determined in a laboratory, an increase of the uncertainty is to be expected in the application in an industrial environment. This can be taken into consideration by a scaling of the hypercuboid, wherein an individual scaling can be performed for each dimension of the input space, for example.

### LIST OF REFERENCE SIGNS

S1 first step
S2 second step
S3 third step
S4 fourth step
S5 fifth step
S6 sixth step
10 control value
12 interval
14 point
16 hypercuboid

1-11. (canceled)

12. A method for operating a production system that produces a component from a semifinished product having at least one semifinished product property in a process that is characterized by a parameter set comprising at least one process parameter, wherein the parameter set is specified and/or a component quality is ascertained by a trained model based on the at least one semifinished product property, and a stability of the trained model is determined according to the method, the method comprising:
detecting at least one error value of the at least one semifinished product property and/or at least one state variable and/or the at least one process parameter and/or the component quality;
forming a data set for the at least one semifinished product, which, for the at least one semifinished product property, comprises a semifinished product value with the associated error value and/or the state variable with the associated error value and/or the at least one process parameter with the associated error value and/or the component quality with the associated error value;
selecting at least one control value in an interval formed by the respective error value around the semifinished product value and/or the state variable and/or the process parameter and/or the component quality;
forming a control set that comprises correspondence data using the trained model based on the at least one selected control value;
forming a difference between the data set and the control set; and
deriving a threshold value from the difference.

13. The method according to claim 12, comprising:
in response to the difference being less than the threshold value:
using the model for the operation of the production system, and producing the parameter set.

14. The method according to claim 12, comprising:
forming the data set as a hypercuboid, wherein a center point of the hypercuboid is formed by the at least one semifinished product value and/or the at least one state variable and/or the at least one process parameter and/or the component quality, and wherein a respective edge length of which is specified by the associated error values.

15. The method according to claim 12, comprising:
selecting the at least one control value by a sample taking method and/or by an optimization method.

16. The method according to claim 15,
wherein the sample taking method comprises a Latin hypercube method.

17. The method according to claim 12, comprising:
forming an aggregated difference in response to at least two control values being used such that the difference comprises at least two difference values.

18. The method according to claim 17, comprising:
deriving the threshold value by a statistical assessment of the aggregated difference and/or by a target specification.

19. The method according to claim 12, comprising:
in response to the difference being greater than the threshold value, outputting a warning signal and/or proposing a further trained model and/or an updated training data.

20. The method according to claim 12, comprising:
using, for the at least one data set, the at least one semifinished product value and/or the at least one state variable and/or the at least one process parameter and/or the component quality of a training data set and/or a validation data set and/or operating data set and/or artificial data set.

21. A non-transitory computer readable medium having stored thereon, a program that, when executed by a computing device of a production system, cause the computing device to perform the method according to claim 12.
